(19) United States
(12) Patent Application Publication
(10) Pub. No.: US 2006/0137492 A1
(43) Pub. Date: Jun. 29, 2006

(54) Reversible Ratcheting Open-End Wrench

(75) Inventor: Richard Dwaine Melos, Lynchburg, VA (US)

Correspondence Address: RICHARD DWAINE MELOS, 917 OLD TRENTS FERRY ROAD, LYNCHBURG, VA, 24503, US

(73) Assignee: Richard Dwaine Melos, Lynchburg, VA (US)

(21) Appl. No.: 10/905,295

(22) Filed: Dec. 24, 2004

(51) Int. Cl. B25B 13/46

(52) U.S. Cl. 81/58.2; 81/62

(57) ABSTRACT

This is a fully-rotating open-end wrench with two ratchets that are linked together by a tie-bar so that the ratchets remain in synchronization while they are applying torque against a center circumferentially notched gear. The center gear has an internal hexagonally shaped opening that is used to engage a standard nut or bolt. As the center notched gear turns, one, the other or both of the ratchets are engaged in the notches on the periphery of the gear. A spring loaded plunger keeps pressure on the tie-bar so that torque can be applied in either a clockwise or a counterclockwise direction against the gear. The direction of rotation of the ratchets can be quickly reversed by putting pressure on the edge of the tie-bar thus forcing the v-shaped protrusion on the tie bar past the v-shaped nose of the spring-loaded plunger.

### BACKGROUND OF THE INVENTION

1. Field of the Invention

This invention is a fully-rotating reversible open-end wrench with two synchronized ratchets that are kept in synchronization by a tie-bar which in turn is under pressure from a spring loaded plunger.

2. Description of Prior Art

U.S. Pat. No. 1,060,185 uses two sets of notches on its center gear. The two pawls are connected to each other by spring steel (item 12) and pins (item 39).

The present invention replaces the double notched center gear with a center gear that has only one set of notches which can prevent both clockwise and counterclockwise motion. The relatively weak spring steel (item 12) and pins (items 39) in the prior art are replaced by a much stronger tie-bar that cannot fail from stress fractures. The detent mechanism in the prior art (A1-A6) have been replaced in the present invention by one spring loaded plunger.

U.S. Pat. No. 2,376,575 uses a cam mechanism to inhibit two out of four spring-loaded plungers from engaging in the outer teeth on a center gear thus allowing the center gear to rotate in only one direction. In actual practice when torque is applied to the center gear then rotation is prevented by pushing the pins sideways and into the walls of the pins holes. If enough torque is applied then the pins will snap off or else will wear away the material on the sides of the pin holes. Precision drilled and reamed holes are not conducive to mass production.

The present invention has arisen to simplify construction and allow mass production.

Any pressure against the ratchets in the present invention is transferred directly to the pivotal pins in the center of the ratchets and from the pins to the body of the wrench. Both the ratchet and tie-bar can be stamped out by a die and require no further machining.

U.S. Pat. Nos. 2,551,669 and 4,926,720 allow rotation in one direction only.

U.S. Pat. No. 2,851,914 uses two spring steel “flexible actuating strips” to connect the motion of the two pawls. Narrow grooves were used along the walls of this wrench to limit the sideward motion of the “flexible actuating strips”. The motion of the pawls (item 21) is stopped by allowing the pawls to hit the wall (item 36) of the wrench body.

The present invention eliminates the “flexible actuating strips” which would fail by fracturing from repeated use and stress on the long brittle strips. The present invention replaces all the inner workings of this prior art by connecting the two pawls directly together by a tie-bar which cannot fracture under repeated use or stress. The present invention does not allow the pawls to hit any side wall, the motion of the pawls is limited by its engagement with the periphery of a notched gear.

U.S. Pat. No. 6,559,613 is a gear driven open-end wrench that is powered through a spur gear train. It is unlike the present mechanism in that it has no quickly reversing ratchet mechanism.

### SUMMARY OF THE INVENTION

The objective of this invention is to provide an open-end ratcheting wrench with the simplest ratcheting mechanism possible and with an internal ratcheting mechanism that will avail itself to mass production with die stamping techniques.

The rotating gear that drives a hexagonal nut or bolt head has a notched periphery that is in constant engagement with one or the other or both ratchets. The gear rides in a grooved housing and is capable of full rotation. The ratchets maintain constant contact with the periphery of the gear or with the opening of the gear since they are under continual pressure from a tie-bar which is forced to one side or the other by a spring loaded plunger. By exerting pressure on the outer edge of the tie-bar, the protruding center notch on the tie-bar can be forced past the v-shaped nose of the plunger thus causing the plunger nose to exert pressure on the tie-bar in the opposite direction. Thus the two ratchets can be forced to swivel on their respective pivotal center pins simultaneously and prevent the gear from either clockwise or counterclockwise rotation.

The movement of the ratchets must be synchronized by the tie-bar so that either ratchet may re-engage the notched gear as the opening in the gear travels past one of the ratchets. If the ratchets prevent clockwise rotation of the gear then at the same time they will allow counterclockwise rotation of the gear and visa versa.

The ratchets transfer any pressure exerted by the gear directly to the pivotal pins that the ratchets swivel on and pressure is then transferred from the pins to the body of the wrench. The ratchets provide a positive lock when the gear exerts pressure on them thus allowing externally produced torque to apply directly to the driven nut or bolt.

### BRIEF DESCRIPTION OF THE DRAWINGS

FIG. 1 is an exploded view of the wrench showing all included parts.

FIG. 2 is an exploded view of the bottom half of the wrench.

FIG. 3 contains a top view and an isometric view of the fully assembled bottom half of the wrench.

FIG. 4 shows a top view of the fully assembled bottom half of the wrench and a cross section view taken along line A-A.

FIG. 5 is an exploded view of the top half of the wrench.

FIG. 6 contains a top view and an isometric view of the fully assembled top half of the wrench.

FIG. 7 is a top view, side view and isometric view of the rotating gear.

FIG. 8 is a top view, side view and isometric view of one of the two identical ratchets.

FIG. 9 is a top view, side view and isometric view of the tie-bar.

FIG. 10 is a top view, side view and isometric view of the sliding plunger.

FIG. 11 contains four views of the final assembly starting with the top view (lower left), side view (middle left), bottom view (top left) and an isometric view.

### REFERENCE NUMERALS IN DRAWINGS

All individual parts carry the same part number throughout all eleven figures.
1. Bottom half of body of wrench 7. Plunger
2. Notched gear with socket opening 8. Top half of body of wrench
3. Ratchet 9. Alignment pins
4. Tie-bar 10. Pivotal pins for the ratchets
5. Spring 11. Small Flat head machine screws
6. Set-screw 12. Large Flat head machine screws

### DETAILED DESCRIPTION OF THE PREFERRED EMBODIMENT

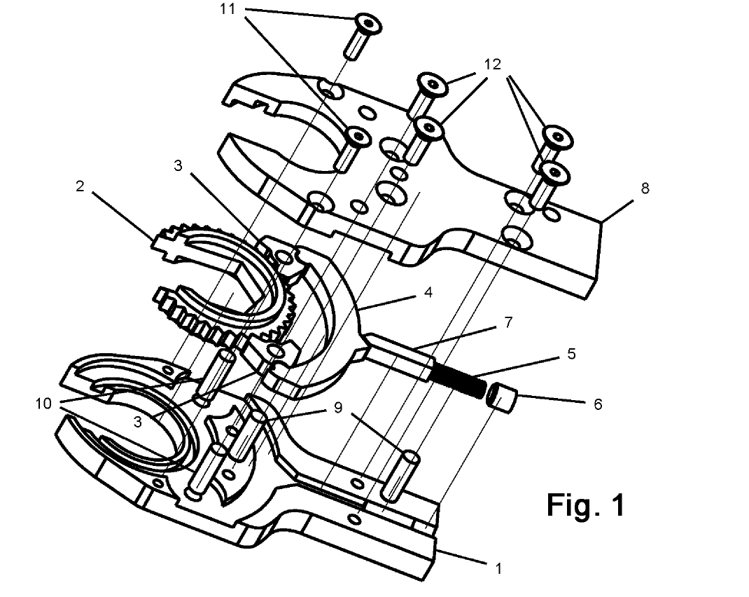

Referring to FIG. 1, the gear (2) has a hexagonal opening which can receive a driven nut or bolt. The opening may be of any standard size. The gear has v-shaped notches on its remaining periphery in order to engage similarly shaped projections on both of the ratchets (3). The gear has sideward protrusions that ride in the bottom half (1) and also in the top half (8). The protrusions keep the gear axially centered on the body (1 and 8) of the wrench and constrain the gear the correct distance from the axis of the pivotal ratchet pins (10) thus maintaining a constant contact of the ratchets (3) with the periphery of the notched gear (2) without allowing the ratchets to bind on the notches on the gear.

Still referring to FIG. 1, the tie-bar (4) is received in a similarly shaped cavity in both the top half of the body (8) and the bottom half of the body (1). The width of the tie-bar is equally encased half in the top body and half in the body. The tie-bar rotates about the same axial center as the gear (2). However, the rotation of the tie-bar is limited since it has two round protrusions that engage in similarly shaped round cutouts in the ratchets (3) and in turn both of the ratchet's are limited in their rotation about their respective pins (10) by engagement with the periphery of the notched gear (2). The limited rotation of the ratchets (3) about their respective pins (10) in turn limits the sideward movement of the tie-bar (4).

Again referring to FIG. 1, threaded set-screw (6) is engaged in threads that are formed half in the top body (8) and half in the bottom body (1). The sole purpose of the set-screw is to retain spring (5) from falling out. Spring (5) maintains constant pressure against the back of the plunger (7). The back side of the plunger (7) is flat in order to maintain constant pressure against spring (5). The front side of plunger (7) has a v-shape which maintains constant pressure against either side of the similar v-shaped protrusion on the center back of the tie-bar (4). The constant sideward pressure against tie-bar (4) is necessary in order to maintain continuous equal pressure on both of the ratchets (3) which in turn ride on the notched periphery of the gear (2). The ratchets move in unison with one another. The rotational movement of each ratchet about its respective pivotal pin is duplicated exactly by the other ratchet. This synchronization in rotational movement of the ratchets is achieved by the swiveling connection of the cutout in each ratchet to the two round protrusions on the tie-bar (4).

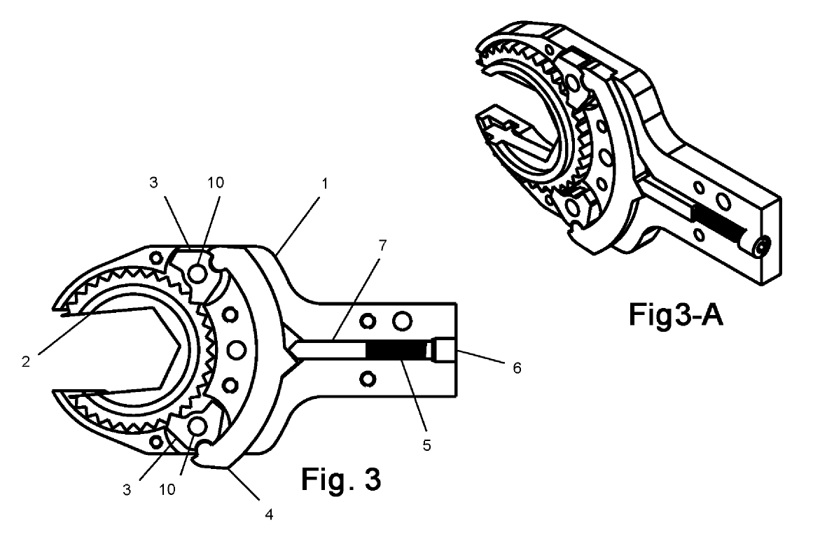

Looking at the top view in FIG. 3, the plunger (7) is putting continual sideward pressure against the v-shaped protrusion on the tie-bar (4). The two round protrusions on the tie-bar ride freely in the round cutouts on the two ratchets (3). In this case, the two ratchets are forced by the tie-bar to rotate in a clockwise direction while swiveling about their respective pins (10). As the gear (2) rotates in a clockwise direction, the tip of the ratchets will ride on the gear's notched periphery. However, if the gear attempts to rotate in a counterclockwise direction then the tip of the ratchets will lock the gear in place and prevent the gear from turning.

Again referring to FIG. 3, notice that one edge of the tie-bar (4) is extending past the side of the body (1). By manually pushing on the edge of the tie-bar that is extending past the body, the pressure of the spring loaded plunger (7) can be overcome and the v-shaped protrusion on the tie-bar (4) can be forced past the v-shaped nose on the plunger (7) causing constant pressure on the tie-bar in the opposite direction and causing the two ratchets to maintain counterclockwise rotation thus allowing only counterclockwise rotation of gear (2). In this case, the gear (2) will be prevented from rotation in a clockwise direction because the tip of the ratchets would lock the gear in place.

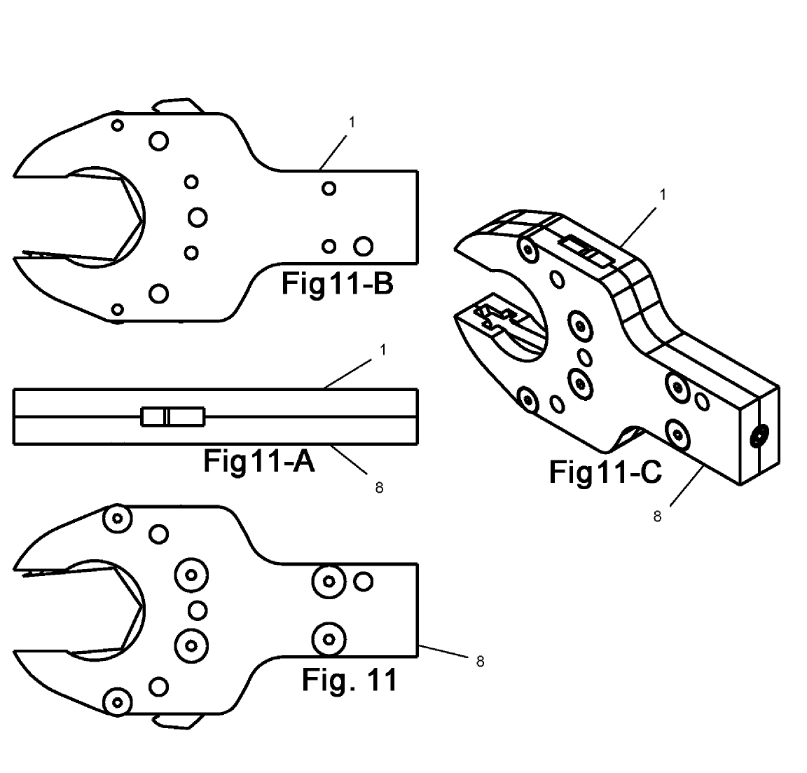

Referring back to FIG. 1, ratchet pins (10) are engaged in the top half of the body (8) and the bottom half of the body (1) while the ratchets (3) pivot freely about them. The two pins (9) align the top and bottom halves of the body. Flat head machine screws (11 and 12) fasten the top (8) and bottom (1) halves together. Machine screws (11) are slightly smaller than machine screws (12) because of space constraints. The gear (2), the ratchets (3), the tie-bar (4), the sliding plunger (1), the spring (5) and the set screw (6) all are sandwiched between the top and bottom halves of the body upon final assembly as seen in FIG. 11.

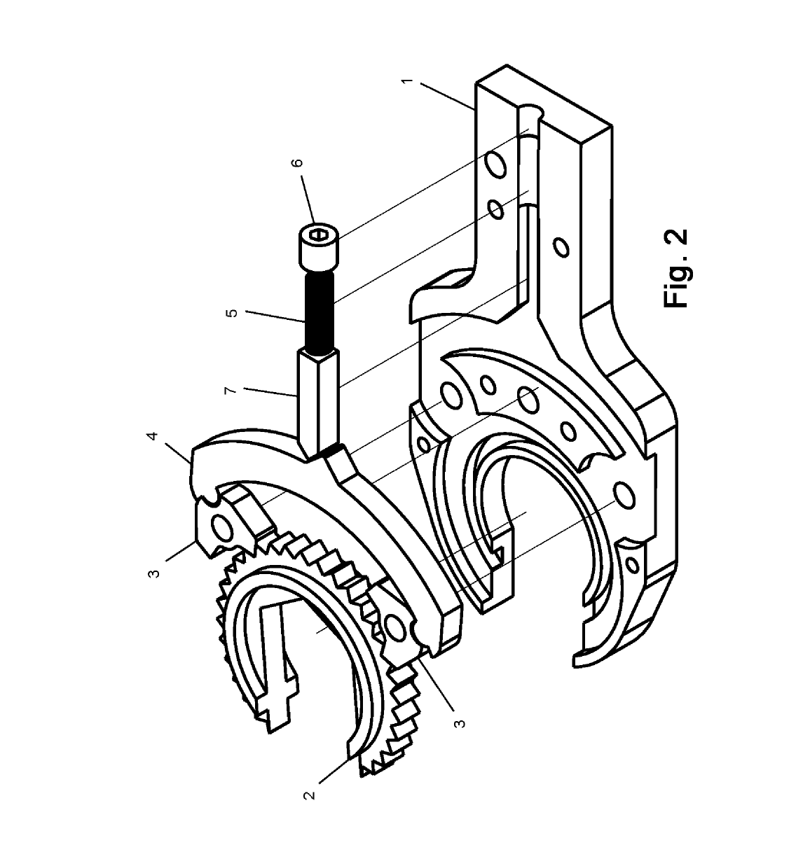

FIG. 2 shows an exploded view of the bottom half of the wrench with all the movable parts (2,3,4,5,7) hovering above the bottom half of the body (1). The set screw (6) does not move but merely retains the spring (5). All the parts (2,3,4,5,6,7) fit half way in their respective cavities in the bottom half (1) and halfway in their matching respective cavities in the top half (part 8 in FIG. 1).

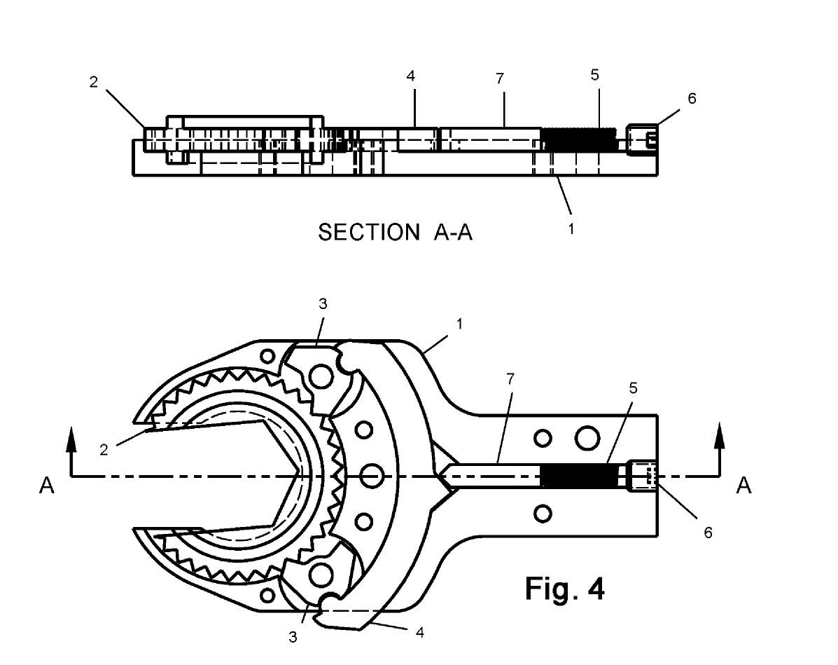

FIG. 4 shows a fully assembled bottom half with a cutaway view along line A-A.

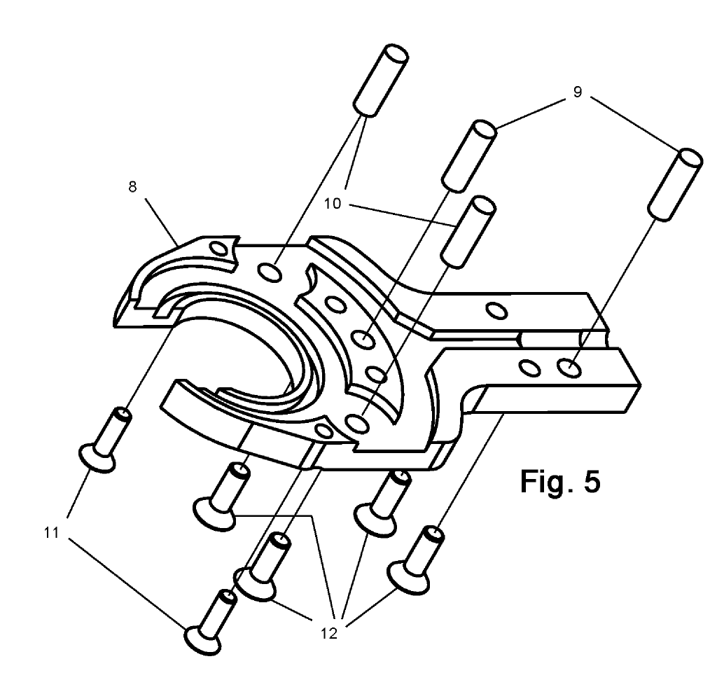

FIG. 5 shows an exploded view of the top half. The pins (9 and 10) engage equally in the bottom and top halves of the final assembly. The flat-head machine screws (11 and 12) pass through a clearance hole in the top body (8) and thread into the bottom body (part 1 in FIG. 1).

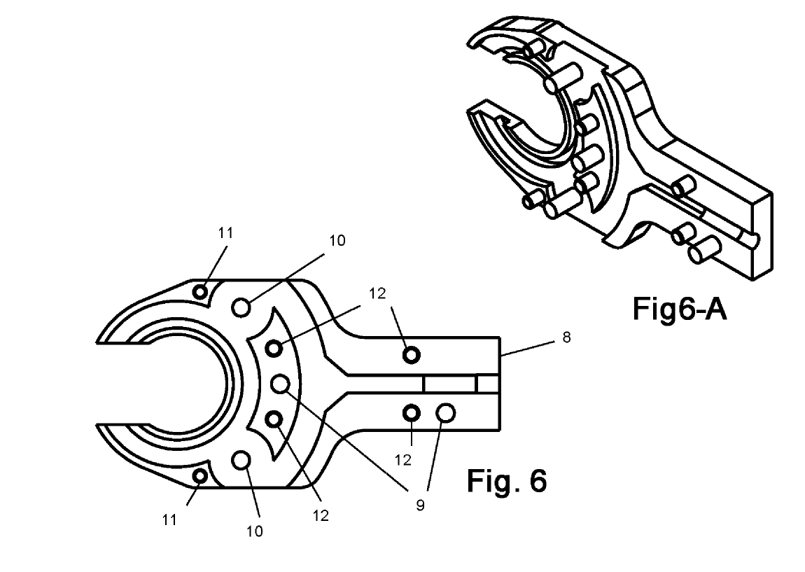

FIG. 6 show a fully assembled top half with its installed pins (9 and 10) and its installed machine screws (11 and 12).

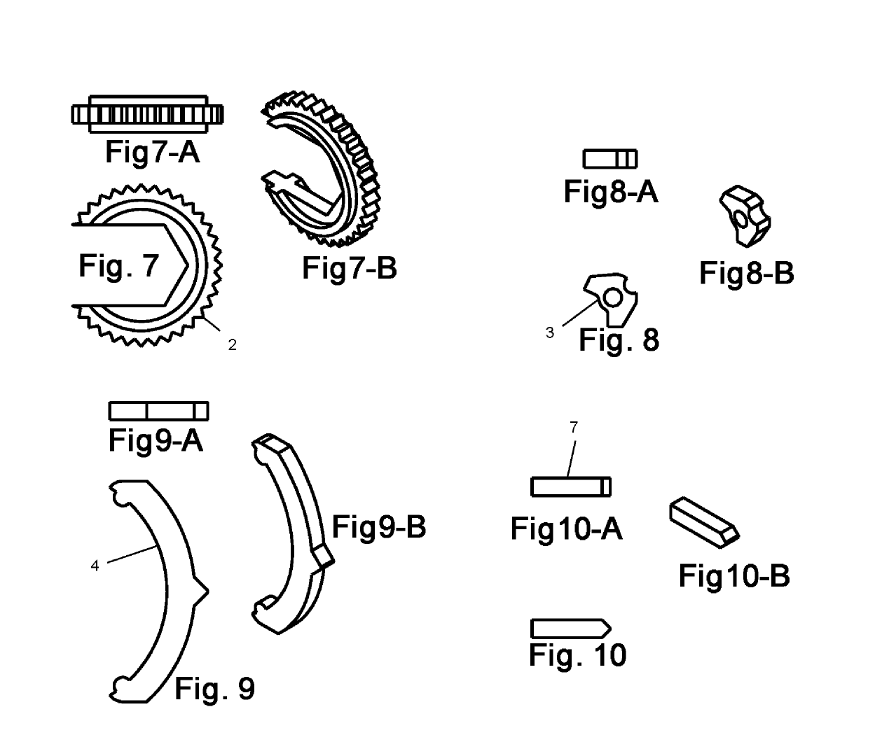

FIG. 7 shows a top, side and isometric view of the gear (2). This gear shows a notched tooth radially spaced every 10 degrees about the center of the gear for a total of 36 teeth before the socket opening was cut into the gear. The peripheral teeth could just as easily be radially spaced every 5 degrees apart or have any spacing that resulted in an even number of teeth as long as the two v-shaped protrusions on each ratchet have the same shape as the notches on the periphery of the gear thus allowing the ratchet teeth to engage fully with the notches on the periphery of the gear.

FIG. 8 shows a top, side and isometric view representative of both of the two identical ratchets. The ratchets have a hole in the middle of their bodies that allow for a pin to pass through. The ratchets rotate freely on their respective pins. The rotational movement of each ratchet is limited by the periphery of the gear. As the gear in FIG. 7 rotates about its axis, one of the ratchets may end up hovering over the socket opening in the gear. In this case, the movement of the hovering ratchet is synchronized by the tie-bar with the movement of the other ratchet that is still engaged in the periphery of the gear. This way the hovering ratchet will re-engage with the gear as the socket opening rotates past it.

FIG. 9 shows a top, side and isometric view of the tie-bar. This tie-bar is semi-circular in construction and rides in similarly shaped cavity in the top and bottom halves of the body of the wrench. The tie-bar synchronizes the movement of the two ratchets and spring loaded pressure is maintained against the tie-bar in either a clockwise or counterclockwise direction.

The tie-bar is the differentiating element between the present invention and the prior art. Prior art (U.S. Pat. Nos. 2,851,914 and 1,060,185) have too many moving parts to be practical for mass production. The many moving parts have been replaced by a singular tie-bar.

FIG. 10 shows a top, side and isometric view of the spring loaded sliding pin. The pin and its adjoining spring (part 5 in FIG. 1) could be replaced by any spring loaded mechanism that maintained reversible clockwise or counterclockwise pressure against the v-shaped notch on the tie-bar.

The top an bottom halves of the body (parts 1 and 8 in FIG. 1) could easily be replaced by flat stamped sheet metal, forged steel, or die cast parts as long as the gear was constrained from moving radially and was allowed to rotate about its own axis and as long as an opening was created for a nut or bolt to enter the socket opening of the gear. In all cases, the distance from the center pivotal axis of the gear to the center pivotal axis of both ratchets must be maintained so that the periphery of the gear doesn't bind on the periphery of the ratchet. Also, in all cases, a spring loaded tie-bar must synchronize the rotational movement of the ratchets about their respective pivotal axis.

This wrench was shown throughout the FIGS. 1-11 without a handle to be used for gripping. The end of the wrench near the set screw (6) can be extended to any length for use as a handle. It may also be convenient to install a detachable handle that would attach to the body of the wrench by any quick-disconnect mechanism.

What is claimed is:

1. A fully-rotating reversible open-end ratcheting wrench comprising:
a. a peripherally notched gear that has a cutout sized to receive a standard size nut or bolt head and,
b. both sides of said gear will have round projections that share the same center axis as the gear's notched circumference and,
c. said round projections will ride in similarly sized cutouts in the top and bottom halves of the wrench and the gear will be sandwiched between the two halves of the wrench whether the top and bottom halves are stamped steel, forged steel, machined, die-cast or molded and,
d. two ratchets placed a distance apart to straddle the opening of the gear as the gear rotates about its center axis and,
e. said ratchets are free to pivot on their respective pins and,
f. said ratchets are synchronized in their rotation about their respective pivotal pins by their connection to a linkage or tie-bar that constrains them to move in unison,
g. said ratchets have two tips each with all four tips with the same shape as the notches on the periphery of the gear and,
h. said ratchets are urged to pivot about their respective pivotal pins in either a clockwise or counterclockwise direction depending upon the urging of the tie-bar and,
i. when the ratchets are urged in a clockwise direction, their tips will ride on the notched periphery of the gear while allowing clockwise rotation of the gear but the ratchets will lock the gear from moving in a counterclockwise direction and,
j. conversely, when the ratchets are urged in a counterclockwise direction, their tips will ride on the notched periphery of the gear while allowing counterclockwise rotation of the gear but the ratchets will lock the gear from moving in a clockwise direction and,
k. said tie-bar or linkage has a v-shaped center protrusion that is urged to either side by riding against the v-shaped nose on a spring-loaded plunger and,
l. pressure can be applied to the edge of the tie-bar that protrudes beyond the body of the wrench to force the v-shaped protrusion on the tie-bar to overcome the pressure exerted by the v-shaped nose of the spring loaded plunger thus causing the linked ratchets to reverse their direction of rotation and,
m. the plunger is slidably sandwiched halfway between the top and bottom halves of the wrench and linearly aligned with a spring and retaining set-screw and,
n. all moving parts, the gear, two ratchets, tie-bar, plunger, spring and set screw, are equally sandwiched between the top an bottom halves of the wrench.

2. (canceled)
